(19) United States
(12) Patent Application Publication
(10) Pub. No.: US 2014/0341582 A1
(43) Pub. Date: Nov. 20, 2014

(54) SYSTEMS AND METHODS FOR SINGLE WAVELENGTH WITH DUAL CHANNELS FOR CONTROL SIGNAL AND INTERNET DATA TRANSMISSION

(71) Applicant: North Carolina State University, Raleigh, NC (US)

(72) Inventors: Leda M. Lunardi, Raleigh, NC (US); Subhashish Bhattacharya, Raleigh, NC (US); Tie Wu, Raleigh, NC (US)

(73) Assignee: North Carolina State University, Raleigh, NC (US)

(21) Appl. No.: 14/202,800

(22) Filed: Mar. 10, 2014

Related U.S. Application Data
(60) Provisional application No. 61/775,353, filed on Mar. 8, 2013.

(51) Int. Cl. H04J 14/02

(52) U.S. Cl. CPC H04J 14/0221
USPC 398/79

(57) ABSTRACT

Systems and methods for single wavelength with dual channels for control signal and Internet data transmission are disclosed. According to an aspect, a network unit may include a communications module configured to receive a single wavelength signal having first and second channels. The first channel may carry Internet data. The second channel may carry power grid control and monitoring data. Further, the network unit may include a multiplexer configured to multiplex the Internet data and the power grid control and monitoring data.

### CROSS REFERENCE TO RELATED APPLICATION

This application claims the benefit of U.S. Provisional Patent Application No. 61/775,353, filed Mar. 8, 2013 and titled SYSTEMS AND METHODS FOR SINGLE WAVELENGTH WITH DUAL CHANNELS FOR CONTROL SIGNAL AND INTERNET DATA TRANSMISSION, the content of which is hereby incorporated herein by reference in its entirety.

### TECHNICAL FIELD

The present disclosure relates to control signal and data transmission. More particularly, the present disclosure relates to systems and methods for single wavelength with dual channels for control signal and Internet data transmission.

### BACKGROUND

Today, two important topics include global warming and technologies related to green power or renewable energy resources. These topics have motivated researchers to produce the next generation of electric power-grids (NGEPGs), or also referred as “Smart-Grid.” At the beginning of the century, Smart-Grid systems provided only one-way broadcast on demand traditional electric power grid to an integrated, interactive power transmission network or sub-networks. More recently, few renewable energy sources have been integrated and distributed through Smart-Grid systems, though not really available to customers everywhere. An important feature for intelligent electric power-grid is relying on a two-way telecommunication system and broadband communication networks. Without broadband communication network and reliable two-way telecommunication systems, the network may be unable to perform the tasks of the traditional electric power grid in addition to manage renewable sources. Proposals for better management of the electric power grid still are short of two-way reliable telecommunication system. For example, intelligence distribution concepts for storage and energy management as well as fault isolation have been combined in solid state transformers (SST). Some utility providers have employed automated “smart” meters, even though, reliable and secure two-way telecommunication system, as the first step of “Smart-Grid” systems.

The NGEPG has also drawn significant attention because of its renewable energy, smart control systems, high efficiency energy delivery, and management. A key advance of NGEPG is the reliable and secure two-way communication system between the energy providers, service providers, and customers. According to the intelligent features of NGEPG, such as real-time monitoring, relay protection, the data of NGEPG must be delivered with delay times shorter than 3 milliseconds for relay protection and 16 milliseconds for monitoring. Also, concerning to NGEPG being with many sensors, a lot of faults insulators, numerous power transmission routers under the electromagnetic radiation environment, and against any cyber-attack, an optical fiber communication system no doubt could be the best choice because of its incomparable broadband and reliable quality of service (QoS).

For at least the aforementioned reasons, it is desired to provide improved equipment, systems, and techniques related to NGEPG.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for single wavelength with dual channels for control signal and Internet data transmission. According to an aspect, a network unit may include a communications module configured to receive a single wavelength signal having first and second channels. The first channel may carry Internet data. The second channel may carry power grid control and monitoring data. Further, the network unit may include a multiplexer configured to multiplex the Internet data and the power grid control and monitoring data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a diagram of an example core network of an architecture indicating an electric power grid (NGEPG) connected to different energy sources, electric power transmission and distribution equipment, power smart meters, end customer computers, television, and through the PON architecture;

FIG. 2 is a block diagram of an example architecture of two-way optical fiber communication NGEPG system in accordance with embodiments of the present subject matter;

FIGS. 3A-3D are graphs of an optical spectrum of dual channels for NGEPG in accordance with embodiments of the present subject matter;

FIG. 4 is the bit-error-rate results analysis for the eye diagrams for single channel wavelength with dual channels at 10 Gbit/s/channel and average received optical power of −22.15 dBm;

FIG. 5 is a graph showing an example BER test result for single wavelength with dual channels at 5 Gbit/s/channel and average received optical power of −24.55 dBm;

FIG. 6 is a graph showing an example BER test result for 1300 nm wavelength 1 Gbit/s/channel and average received optical power of −25.70 dBm;

FIG. 7 is a graph showing example BER measurements for each channel when transmission length was set at 20 km and dual channels were set at balanced optical power at the receivers;

FIG. 8A is a block diagram of an example test system in accordance with embodiments of the present subject matter;

FIG. 8B is a graph showing an example profile of combined data of FIG. 8A;

FIG. 9 is a block diagram of an example OLT in accordance with embodiments; and

FIG. 10 is a block diagram of an example ONU in accordance with embodiments.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Systems and methods for single wavelength with dual channels for control signal and Internet data transmission are disclosed. According to an aspect, commercial optical fiber two-way communication systems are provided for NGEPG. High priority protection of NGEPG without delay, disruption and high speed switching of electric power routing may be provided in accordance with embodiments disclosed herein.

In accordance with embodiments of the present subject matter, an optical fiber two-way communication system based on a passive optical network (PON) architecture is disclosed. In an example, a PON system may have a single wavelength with dual channels for power-grid controlling signal and high bit rate (e.g., IEEE 802.3av) data of the Internet information transmission. The PON system may be based on low cost broadband optical modulators (CMOS-compatible, polymer or graphene-based).

In accordance with embodiments of the present subject matter, systems and methods are disclosed for providing a fast and secure optical communication scheme for NGEPG. The present disclosure provides a solution to the problem of using current Internet and available lightwave technology to deliver Internet data to customers and to transmit control and monitoring data of NGEPG to power grid devices and central office. In accordance with embodiments of the present disclosure, systems and methods disclosed herein utilize a single wavelength with dual channels to deliver Internet and power grid data. The data may be provided from a central office to user side terminations based on a PON. Systems disclosed herein may optical fiber composite low-voltage cable (OPLC) that is available in the access networks. Further, systems disclosed herein may implement IEEE 802.3av standards for PON such that the optical fiber communication system has 10 Gb/s of downstream data with delay less 3 milliseconds and 1 Gb/s upstream data with delay less than 16 milliseconds between the optical line terminal (OLT) and optical network unit (ONU) with 20 Km optical fiber. Systems disclosed herein may be upgradable to other PON-type architectures such as, but not limited to, dense WDM (DWDM) PON. Further, systems disclosed herein may be configured to provide security against the cyber-attack to NGEPG data in the Internet, single wavelength with dual channels can provide independent special hardware and software processing.

Systems and method disclosed herein may use a single wavelength with dual channels to deliver power grid data and Internet data at the same time by separated channels. The different modulation format and different security protection can be applied to the two separated channels to ensure smaller data delay.

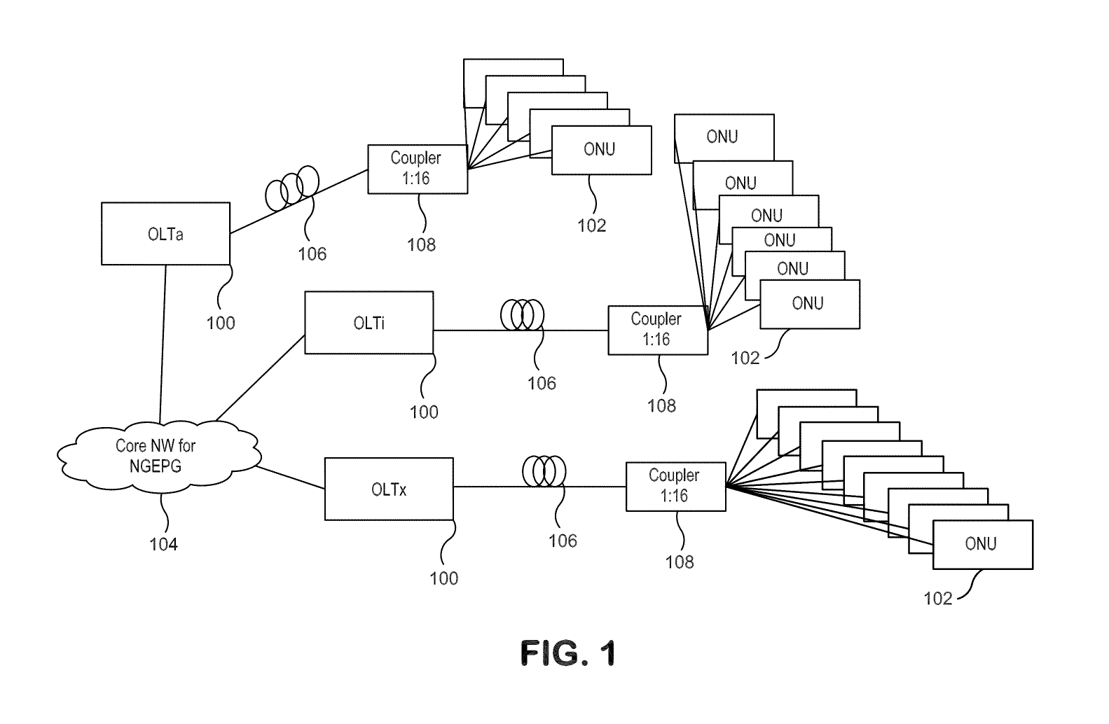

A two-way telecommunication network disclosed herein can include a core network and access network. Disclosed herein is an architecture of a single wavelength with two channels to transmit two different type of digital signals. One signal is the PWM controlling signal for the NGEPG. The other signal may be an on and off keying (OOK) signal of information data. FIG. 1 illustrates a diagram of an example core network of an architecture indicating an electric power grid (NGEPG) connected to different energy sources (e.g., wind plants, hydro power plants, nuclear power plants, solar farms, and the like), electric power transmission and distribution equipment, power smart meters, end customer computers, television, and through the PON architecture. Disclosed herein are devices for the optical line terminal (OLT) and the optical network unit (ONU) of the PON for the NGEPG.

FIG. 1 illustrates a block diagram of an example framework of an NGEPG based on PON-type architecture according to embodiments of the present subject matter. Referring to FIG. 1, electric power generation resources and Internet information data are sent to end users. The NGEPG equipment may be protected and controlled by monitoring data and controlling signaling by optical line terminals (OLTs) 100 and optical network units (ONUs) 102 of PON. The OLTs 100 may each be connected to a core network for NGEPG equipment 104. The OLTs 100 and the ONUs 102 may be operatively connected via optical lines 106 and couplers 108.

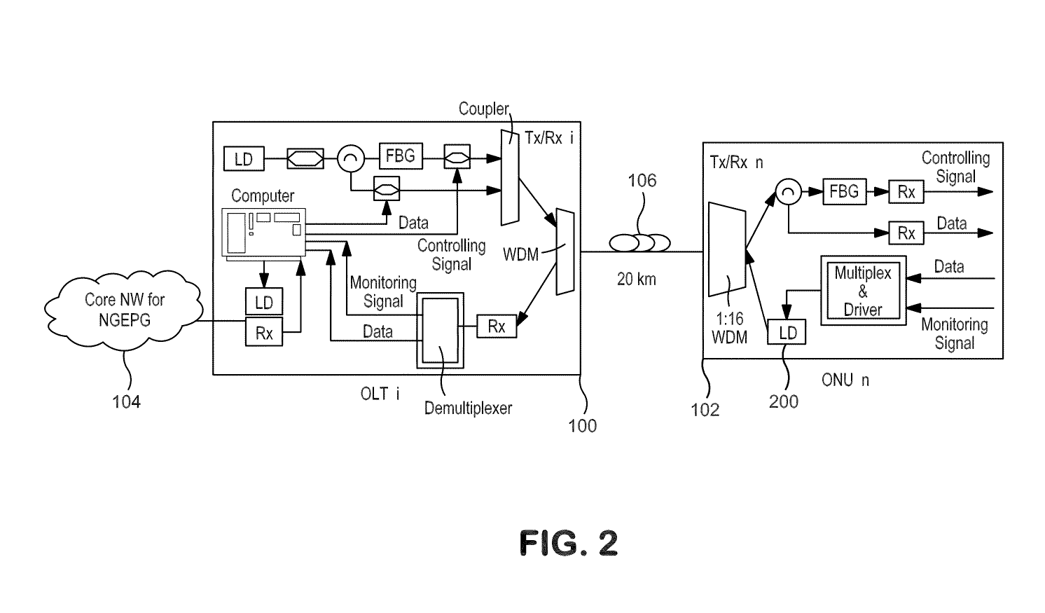

Detailed structure of an OLT and an ONU is shown in FIG. 2, which illustrates a block diagram of an example architecture of two-way optical fiber communication NGEPG system in accordance with embodiments of the present subject matter. The OLT 100 may reside at a service provider's central office. The ONU 102 may reside at an end user's power equipment. In an example, the architecture includes a core network 104 in operative communication with the OLT 100. Further, for example, the OLT 100 may be a suitable card in the central office of the service provider. The ONU 102 may be a suitable card at the end of user side and user side electric power equipment. The card of the OLT 100 may include a laser device 200. For example, the laser device may be a 1550 nm DFB laser 200. An optical carrier suppression of optical intensity modulator (IM) may create dual channels for the NGEPG and may be followed by a high performance light source such as a DFB laser. An optical circulator and a fiber Bragg grating (FBG) may be set behind the optical carrier suppression, which is to separate the dual channels for the two kind type modulation signal of the NGEPG. Two intensity modulator (IM) external modulators may be set after fiber Bragg grating (FBG) and optical circulator for the controlling signal of the electric power equipment and for the information data and Internet service data; the optical coupler couples the Power-grid controlling signal and Internet information data through Wavelength Division Multiplexer (WDM) into the 20˜25 km optical fiber to the ONU card; WDM splits the upstream 1300 nm optical signal to Rx (Photo Detector Receiver) to De-Multiplexer to separate monitoring signal from electric power equipment and information data, both of those signals are sent to the computer (PC board). The computer may analyze the whole data and create the PWM controlling signal to the electric power equipment and send the monitoring signal to the core NW of NGEPG to electric power provider. This computer is one low-level security provider for the NGEPG and IP data provider for the customers of the NGEPG. In the ONU card, WDM splits the 1550 nm downstream optical signal to the optical circulator and FBG which separates PWM optical signal to the Rx to get controlling signal for electric power equipment, OOK optical signal to the other Rx to get the information data (includes Internet data); the information data and monitoring signal are multiplexed to drive the 1300 nm DFB laser through WDM to the 20 km optical fiber to the OLT.

### Dispersion Effects-Transmission Distance Versus Bit Rate:

Referring to FIG. 2, the CW lightwave from LD (DFB), may represented by E₀ (t)=a₀ cos ω_{c}t, here ω_{c} is optical carrier angle frequency, then, the lightwave is modulated by optical carrier suppression (OCS) with RF angle frequency ωₘ. The CW lightwave can be expressed as follows:

E₁(t)=a₋₁ cos(ω_{c}−ωₘ)t+a₀ cos ω_{c}t+a₊₁ cos(ω_{c}+ωₘ)t (1)

After transmitting through z-length optical fiber, the amplitude of CW lightwave becomes

$${E}_{2} ( t ) = {\sum }_{k = 0 , \pm 1} {A}_{k} cos [ ( {ω}_{c} + k {ω}_{m} ) t - β ( {ω}_{c} + k {ω}_{m} ) z ] \qquad ( 2 )$$

where

$$β = \frac{2 π}{{λ}_{c}}$$

is the propagation constant, γ is the optical amplitude attenuation and the following equation is defined: Aₖ=aₖ(t−(ω_{c}+kωₘ)¹β(ω_{c}+kωₘ)z)e^{γz}; (k=0,±1). The photocurrent can be expressed as

$${I}_{2} ( t ) = μ {\vert {E}_{2} ( t , z ) \vert}^{2} \approx \frac{1}{2} μ ( {A}_{0}^{2} + {A}_{+ 1}^{2} + {A}_{- 1}^{2} ) + μ {A}_{0} {\sum }_{k = \pm 1} {A}_{k} cos {ω}_{m} \{ t - [ {β}^{′} ( {ω}_{c} ) + \frac{k}{2} {ω}_{m} {β}^{″} ( {ω}_{c} ) ] z \} + … \qquad ( 3 )$$

where μ is parameter for the system transmission loss and photodiode responsivity, propagation constant β can be expressed as Taylor's expansion:

β(ω_{c}±ωₘ)=β(ω_{c})±ωₘβ′(ω_{c})+1/2ωₘ²β″(ω_{c})+. . . , (4)

In general, for a waveguide mode with an angular frequency ω(β) at the propagation constant β, the group-velocity dispersion parameter D is defined as follows:

$$D = - \frac{2 π \cdot C}{{λ}^{2}} \cdot \frac{{d}^{2} β}{d {ω}^{2}} = - \frac{2 π \cdot C}{{λ}^{2}} {β}^{″} \qquad ( 5 )$$

For the lightwave without modulation, the group velocity is equal to the phase velocity, e.g. v_{g}=vₚ=1/β′. The time shift Δt_{-1, -1} of the codes at ω_{c}−ωₘ & ω_{c}+ωₘ can be expressed as follows:

$$\begin{matrix}Δ {t}_{+ 1 , - 1} = - [ \frac{β ( {ω}_{c} - {ω}_{m} )}{( {ω}_{c} - {ω}_{m} )} z - \frac{β ( {ω}_{c} + {ω}_{m} )}{( {ω}_{c} + {ω}_{m} )} z ] \\ \approx 2 {ω}_{m} {β}^{″} ( {ω}_{c} ) z \\ = 2 {λ}_{c}^{2} {Df}_{m} {C}^{- 1} z\end{matrix} \qquad ( 6 )$$

### If

$$Δ {t}_{+ 1 , - 1 max} -> \frac{τ}{2} = \frac{η}{2 R} ,$$

the degradation of the signal is defined as OK for the detection, the transmission distance can be expressed as follows:

$${z}_{max} \approx \frac{η \cdot C}{4 R {λ}_{c}^{2} {Df}_{m}} \qquad ( 7 )$$

According to the IEEE 802.3av standard, zₘₐₓ is 20 Km. If the fₘ is set as 15 GHz, D is about 17 ps/nm km, C is the speed of lightwave, λ_{c} is the wavelength of the carrier, the bit rate Rₘₐₓ is 10 Gbit/s (For NRZ: β=1) (Note: for bit rate of the each channel be with 5 Gbit/s).

### Noise Effects-BIT-ERROR-RATE Versus Receiver Sensitivity

In the analog optical fiber communication systems, clipping-induced optical signal-to-noise ratio (OSNR) degradation can be proportional to the power addition of channels. In the digital optical fiber communication systems, the performance is measured by the bit-error-rate (BER). To analyze the BER, Eq. (3) can be changed as follows:

$$\begin{matrix}{I}_{S} ( t ) = {I}_{2} ( t ) \\ = μ {\vert {E}_{2} ( t , z ) \vert}^{2} \\ \approx {I}_{0} [ 1 + \frac{1}{\sqrt{ζ}} {\sum }_{k = \pm 1} {m}_{k} ( β , z ) {u}_{k} ( t ) cos {ω}_{m} t + … ]\end{matrix} \qquad ( 8 )$$

where 0≦ζ≦1 is the power suppression ratio of optical carrier. The SNR may be expressed as:

$$O S N R \approx \sqrt{\frac{{P}_{in} {m}_{k}^{2} ( β , z ) {u}_{k}^{2} ( t )}{Ψ {hv}_{c} {B}_{e} ζ}} \qquad ( 9 )$$

where Pᵢₙ is the average power of the optical signal reaching the receiver, mₖ (β, z) is the modulation index, ψ is the noise figure of optical fiber communication system, h is the Planck's constant, υ_{c} is the optical frequency of carrier, Bₑ is the effective spectral width of signal bandwidth, and 0≦ζ≦1 is the optical power suppression ratio of the optical carrier. The relationship between OSNR and BER and Q can be expressed as:

$$\begin{matrix}B E R = \frac{1}{2} erfc ( \sqrt{O S N R} ) & ( 10 ) \\ B E R = erfc ( Q ) ≅ \frac{{e}^{- ( {Q}^{2} / 2 )}}{Q \sqrt{2 π}} & ( 11 )\end{matrix}$$

To obtain a BER of the 10⁻⁹ (Q=6.1), the minimum required optical signal power from the above equation (9-11) can be expressed as (for ASK modulation, uₖ (t)∈(0,1)):

$${p}_{in} = 288 \frac{{hv}_{c} ψ {B}_{e} ζ}{{m}_{k}^{2} ( β , z ) {u}_{k}^{2} ( t )} \qquad ( 12 )$$

For the dual channels case, with a pin Photodiode the minimum achievable receiver sensitivity is around −25 dBm (for PIN). Here the noise figure of the optical system is about 5 dB and the power suppression ratio of optical carrier is selected as 0.9.

### Nonlinear Effects-Channel Space Versus Bit Rate

The crosstalk between two neighbor channels may be created by the fiber nonlinearity. XPM (cross-phase modulation) and FWM (four-wave mixing) are two important sources of nonlinear crosstalk in multichannel fiber communication systems. Comparing two above nonlinearities, the FWM may be the key contribution to the channel crosstalk in the optical fiber communication system with the low bit rate per channel and the narrow channel space. FWM is an intermodulation phenomenon which is created by the Kerr effect in optical systems, whereby interactions between 2 wavelengths (or 2 frequencies) produce 2 extra wavelengths (or 2 extra frequencies) in the signal. It is assumed the optical receiver bandwidth is covered all FWM beating components. Damaging signals to optical system performance can be expressed as:

fᵢⱼₖ=fᵢ+fⱼ−fₖ; (13a)

If FWM is calculated for only two channels, the most damaging signals can be represented as follows:

f_{1,2}=f₁+f₁−f₂;

f_{2,1}=f₂+f₂−f₁; (13b)

Using small-signal approximation, assuming equal optical power for each channel, the crosstalk generated by FWM can be expressed as:

$${σ}_{FWM}^{2} = {\sum }_{i} \frac{4 {P}^{2} {Γ}^{2} {G}_{i}^{2}}{{γ}^{2} + {Δβ}_{i}^{2}} {x}_{i} … i = 1 , 2 \qquad ( 14 )$$

where P is the optical power per channel; Γ=2πn₂/(λⱼA_{eff}) is the nonlinear coefficient of the optical fiber, A_{eff} is the fiber effective index; Gᵢ is the optical gain of each channel, Gᵢ is the degeneracy factor of mixing product, Gᵢ=1 for two-tone products and Gᵢ=2 for three-tone product; xᵢ represents a combined effect of the relative phase between the contributing waves, for two channel ASK modulation xᵢ=1; γ is the fiber loss coefficient that is defined before as Aₖ=aₖ(t−(ω_{c}+kωₘ)⁻¹β(ω_{c}+kωₘ)z)e^{-γz}; (k=0,±1).

$${Δβ}_{i} = \frac{2 {πλ}^{2} D}{c} {\vert ( \begin{matrix}{f}_{i} & {f}_{c}\end{matrix} ) \vert}^{2}$$

is the phase mismatch factor for each channel. If we keep the FWM crosstalk lower than 20 dB, Δfᵢ=|fᵢ−f_{c}| is at least 1.5 times of the bandwidth B_{eff} of photo detector [23], B_{eff}=0.75Rₘₐₓ and Rₘₐₓ is maximum bit rate per channel. D is the fiber chromatic dispersion at f_{c} which is the frequency of optical carrier.

### Results and Discussion

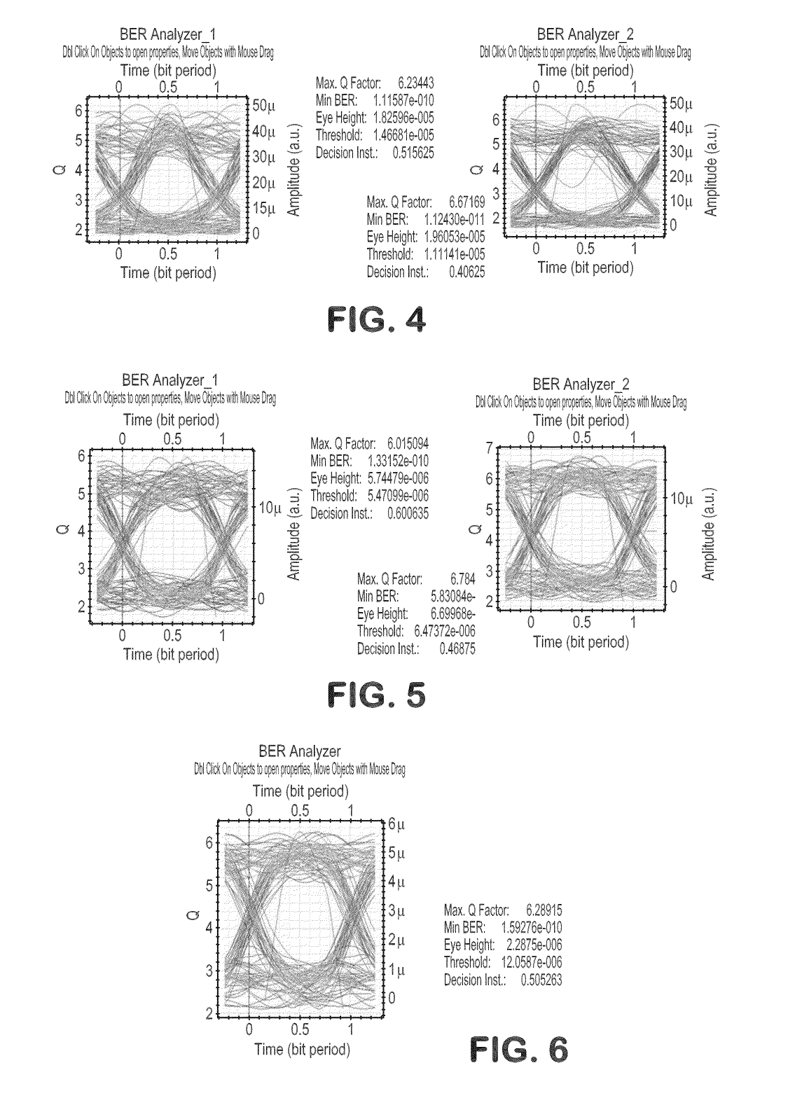

In order to investigate the feasibility of a signal wavelength with dual channels to transmit control data of Power-Grid and Internet data based on PON access network, separately, simulations were performed using Optiwave photonics software available from Optiwave Systems Inc. of Ottawa, Canada. The simulation set in FIG. 4 with 10 Gbit/s downstream data at 1550 nm wavelength with dual channels and 1 Gbit/s upstream data at 1300 nm.

TABLE
The parameters of the optical fiber system experiment

| Active optical components | | Passive optical components | | System parameters | |
|---|---|---|---|---|---|
| DFB laser1: | λ = 1550 nm | 20 Km SMF: | L = 0.2 dB/Km | Optical Power | P = +3 dBm |
| | Δν = 100 MHZ | | D = 17 ps/nm/Km | into SMF: | |
| | Pₒᵤₜ = 0 | | PMD = 0.5 ps/sqrt(Km) | | |
| | dBm = 1 mW | | | | |
| DFB laser2: | λ = 1300 nm | 1 × 16 power splitter: | L = 1 dB | Bit Rate: | 10 Gbit/s/ch @1550 nm |
| | Δν = 100 MHZ | | | | 5 Gbit/s/ch@1550 nm |
| | Pₒᵤₜ = 3 | | | | 1 Gbit/s @1300 nm |
| | dBm = 2 mW | | | | |
| MZ-IM123: | B = 20 GHz | FBG12: | L = 2 dB | BER level: | 10⁻¹⁰ |
| | L = 3.3 dB | | R = 99% | | |
| | ER = 30 dB | | B = 10 GHz | | |
| EDFA: | C-Band | 1 × 2 power combiner12: | L = 1 dB | Degradation: | 1 dB |
| | G = 20 dB | | | | (for Nonlinear crosstalk and |
| | NF = 5 dB | | | | accumulated dispersion, etc.) |
| PD: PIN | L = 1 dB | | | | |
| | G = 3 dB | | | | |
| | F_{cutoff} = 0.75 | | | | |
| | bit rate Hz | | | | |
| | R = 1 A/W | | | | |

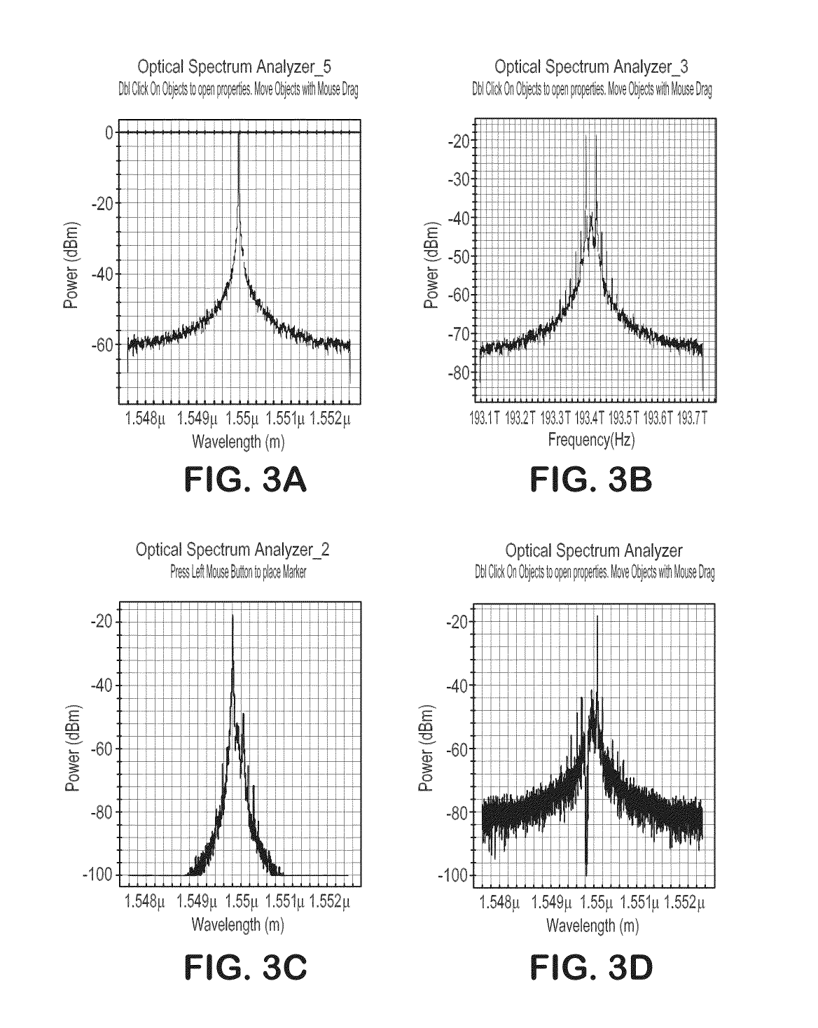

For creation of the dual channels on 1550 nm wavelength (193414.498 GHz), a standard 1550 nm DFB with 0 dBm (=1 mW) output and 100 MHz linewidth, and an external Mach-Zehnder (MZ) optical intensity modulator (IM) with a 20 GHz bandwidth may be utilized. Further, other suitable techniques and equipment may be utilized for low cost approaches. In the OLT, the peak-to-peak driving voltage of 15 GHz sinusoidal signal may be set at twice of the half-wave voltage of the MZ-IM. In this example, the optical central carrier may be suppressed, while the generated two channels (or optical sub-carriers) can be set with more than 20 dB suppression of unwanted side modes. The optical spectrum of DFB laser and dual channels are shown in FIGS. 3A-3D, which illustrates graphs of an optical spectrum of dual channels for NGEPG in accordance with embodiments of the present subject matter. In FIGS. 3A-3D, a DFB laser was set at 1550 nm (193414.489 GHz), one channel was set at 1550.12 nm (or 193429.498 GHz), and another channel was set at 1549.88 nm (or 193399.489 GHz). The optical circulator and FBG (optical fiber Bragg grating) (reflectivity as 0.999, frequency at 193399.489 GHz (or 1549.88 nm), bandwidth 10 GHz, noise dynamic around 3 dB) were used to separate the two channels with −10 dBm of the balanced output to be fed into the two MZ-IM modulators. The two channels optical signals were intensity modulated by 10 Gbit/s/channel 2³¹−1 pseudorandom binary sequence (PRBS) data and 5 Gbit/s/channel 2³¹−1 PRBS data, respectively. The dual channels optical modulated signals were combined by optical coupler and they were fed into the EDFA with 20 dB gain due to the optical power was less than −16 dBm. The 1550 nm and 1300 nm bi-direction multiplexer (MUX) was used for this experiment for bi-direction transmission for downstream and upstream data. At the final part of OLT, MUX sent downstream data to ONU and got upstream data from ONU. Then, the optical signal data with +3 dBm output was fed into the 20 Km single mode fiber (SMF) with 0.2 dB attenuation and 17 ps/nm·km dispersion.

Referring to FIG. 3A, the graph shows the optical spectrum of a 1550 nm DFB laser with 0 dBm output. Optical spectrum linewidth is 100 MHz. Referring to FIG. 3B, the graph shows the optical spectrum of signal wavelength with dual channels with optical carrier supression technique. The channel space was set with 30 GHz (2×15 GHz). The output of each channel optical signal data is about −16 dBm. Referring to FIG. 3C, the graph shows the optical spectrum of one channel at 1549.88 nm (or at 193399.489 GHz). Referring to FIG. 3D, the graph shows the optical spectrum of another channel at 1550.12 nm (or at 193429.498 GHz). FIG. 4 is the bit-error-rate results analysis for the eye diagrams for single channel wavelength with dual channels at 10 Gbit/s/channel and average received optical power of −22.15 dBm.

FIG. 5 is a graph showing an example BER test result for single wavelength with dual channels at 5 Gbit/s/channel and average received optical power of −24.55 dBm.

FIG. 6 is a graph showing an example BER test result for 1300 nm wavelength 1 Gbit/s/channel and average received optical power of −25.70 dBm.

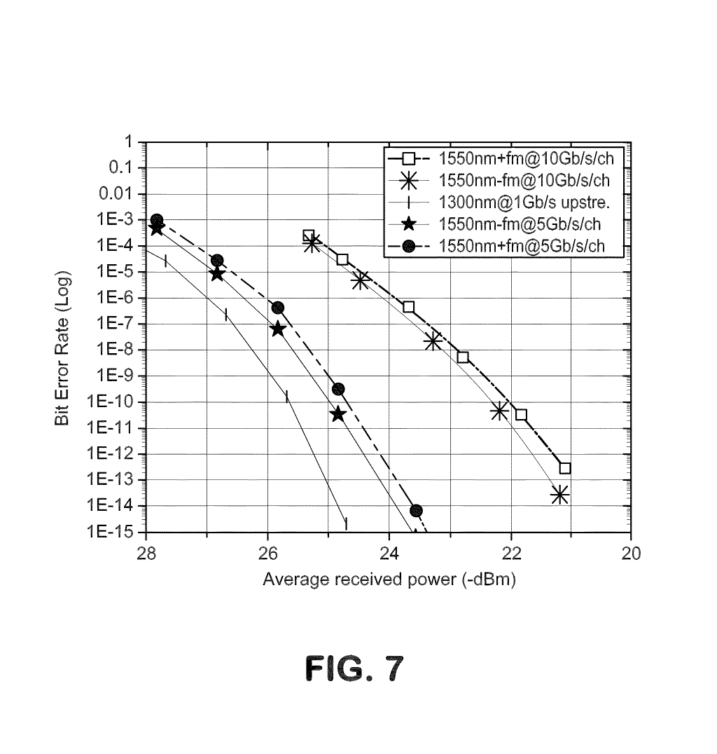

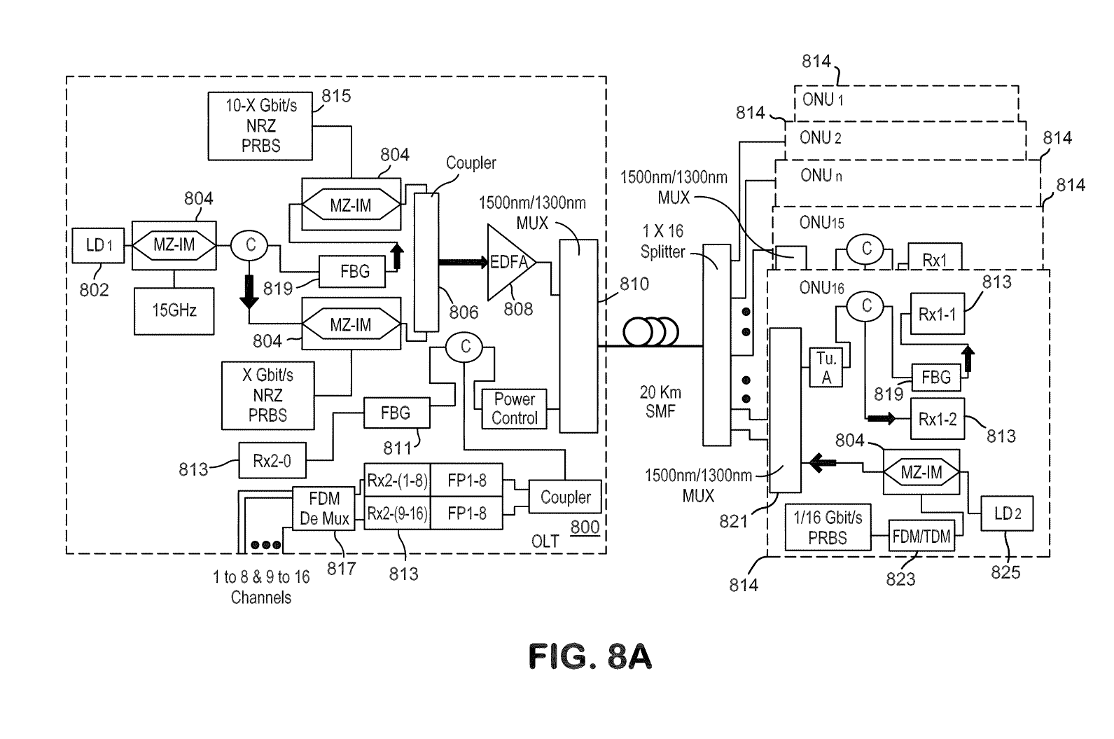

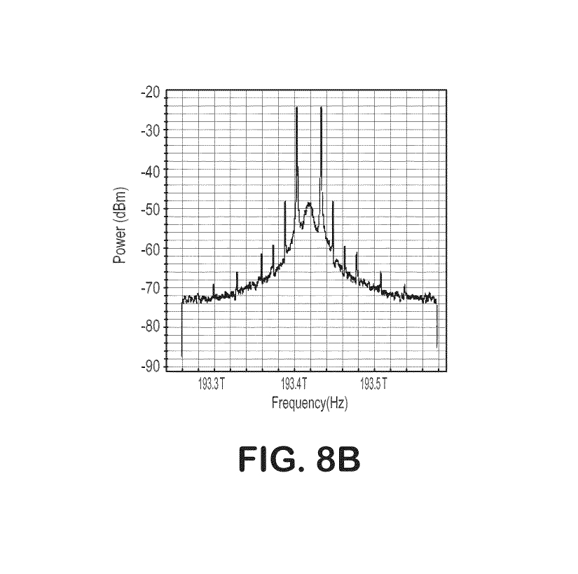

FIG. 7 is a graph showing example BER measurements for each channel when transmission length was set at 20 km and dual channels were set at balanced optical power at the receivers. The graph shows the result with the bit rate being set at 5 Gbit/s/channel and 10 Gbit/s/channel for downstream data. The series 1 is the channel at 1550.12 nm and reflected by FBG in ONU. The series 2 is the channel at 1549.88 nm and by pass FBG in ONU. The series 1 and 2 show performance of dual channels with 5 Gbit/s/channel. The series 3 and 5 show performance of dual channels with 10 Gbit/s/channel. The series 3 is the channel at 1549.88 nm and by pass FBG in ONU. The series 5 is the channel at 1550.12 nm reflected by FBG in ONU. The graph of FIG. 8 also shows the results with the bit rate being set at 1 Gbit/s for upstream data at 1300 nm wavelength.

After transmission through 20 Km SMF, the optical signal was fed into 1×16 power splitter with insert loss 3 dB and optical attenustor. In the ONU, 1550 nm and 1300 nm bi-direction MUX was linked to an 1550 nm optical circulator and 1300 nm directely modulated laser. An optical attenuator was set after 1550 nm optical circulator and to link to a FBG with reflectivity 0.999 at 1550.12 nm (or 193429.489 GHz). The data from dual channels were sent to two PIN photodiodes with cutoff frequency at 0.75×bit rate Hz.

The BER was measured for each channel, i.e. two channels for downstream data and one channel for upstream data. FIG. 7 shows the measured BER as a function of received optical power. To set the BER level of 10¹⁰, the back-to-back sensitivity ranges from −26.5 dBm to −25 dBm for 1550 nm dual channels downstream data at 5 Gbit/s/channel and from −23 dBm to −22 dBm for 1500 nm dual channels downstream data at 10 Gbit/s/channel due to the ripples in the microwave devices. After transmission through the 20 Km SMF, the sensitivity is degraded by less than 1 dB due to weak nonlinearity crosstalk SMF and week accumulated dispersion effects through 20 km. At the ONU, optical power for each channel downstream data at 5 Gbit/s/channel at BER level of 10¹⁰ was around −25 dBm, providing more than 10 dB system margin and providing around 7 dB system margin for downstream data at 10 Gbit/s/channel. FIG. 6 shows the eye diagram of each channel and Q parameter of each channel.

The feasibility of a single wavelength with dual channels for power-grid control data and Internet data has been investigated based on PON architecture for NGEPG by using simulations. The results indicate that there is no evidence of crosstalk between dual channels in a bi-directional transmission data. A 20 Gbit/s downstream data and 1 Gbit/s upstream data were set in the optical test bed. For power-gird control, data can have 50 dB OSNR when it is analog signal through the channel. The investigation approved that it is feasible with a signal wavelength with dual channel for power-grid control data and Internet data as downstream distribution to the customers with 10 Gbit/s to 20 Gbit/s and user data as upstream to the central office (or OLT) with 1 Gbit/s based on PON architecture for NGEPG. An advantage of this implementation is that it is easy to set and fit in the future DWDM PON. The dual channel spacing is only depended on the RF modulation signal (it is more stable without jitter or shift to compare to optical frequency). The power-grid data is easy to protect by hardware to avoid any attack. From the user side, it may not be known that there is another channel for power-grid data delivering through the present Internet.

Although in the disclosed examples the systems and methods described herein utilize fiber optic systems for communicating data, it should be understood by those of skill in the art that the systems and methods may be similarly applied to other communication systems. For example, the disclosed systems and methods may be suitably used in copper wire-based communication systems or wireless-based communication systems.

In accordance with embodiments of the present disclosure, systems described herein may be used for peer-to-peer communications between residences. In this way, local residences may coordinate and share power resources. For example, communication with a peer may be initiated in order to shift power from a peer to another peer requiring extra power. One customer with photovoltaics in the roof of his or her own house now is able to sell back to the grid; however, this user cannot communicate with the next door neighbor or someone down the road. However, by employing the peer communication system disclosed herein, users can start communication peer-to-peer without the central office. In case of emergencies, this can can be used for generation of local power. For example, one peer may plug into a charger requiring extra power, and another one can provide necessary energy.

FIG. 8A illustrates a block diagram of an example test system in accordance with embodiments of the present subject matter. Referring to FIG. 8A, the system includes an OLT 800. The OLT 800 may include a light source (LD1) 802 configured to generate an output of light source (1550 nm). The light source 802 may be a laser diode. An example, profile of the output is shown in FIG. 3A. The OLT 800 may be configured to pass the output of the light source 802 through multiple Mach Zehnder modulators (MZ-IMs) 804 and a coupler 806. Downstream from the MZ-IMs 804, conditioning of the output may be implemented by an optical amplifier (EDFA) 808. The EDFA 808 may be configured with dual channels for encoding and combining power-grid and Internet data. An example of the profile (shape of the optical pulse as function of the wavelength) of the combined data is shown in the graph depicted in FIG. 8B. A MUX 810 may combine this data along with the data of other users and subsequently communicate the combined data downstream. The OLT 800 may include an FBG 811, receivers (Rx) 813, a non return to zero (NRZ) pattern random bit signal (PRBS) device 815, a frequency division de-multiplexer (FDM) 817, an FBG 819, a PRBS 825, and other suitable components that are operatively configured together for implementing the functions disclosed herein.

A spool of optical fiber 812 may be operatively connected to the output of the OLT 800. In this example, the spool 812 is 20 km, but may alternatively be any other suitable length. This may be the length of optical fiber needed to extend between users and utility service providers or stations. After transmission all channels are demultiplexed with each site (ONU) processing independently (combiner/splitter, the Internet and power data receiver/detector separately).

Multiple ONUs 814 may be communicatively connected via a splitter 816 to the optical fiber 812. Example profiles of detected data for an ONU 814 are provided in FIGS. 4-6. Components for handling communication between the power grid Internet data are depicted in the block for the ONU16 814. A light source LD3 (e.g., 1300 nm) may be sent upstream by time division multiplexing, and combined with the other ONU similar signals that may have and detected at OLT. The ONUs 814 may each include an FBG 819, a MUX 821, receivers 813, a laser diode 802, an FDM/TDM device 823, a PRBS 825, and other suitable components that are operatively configured together for implementing the functions disclosed herein.

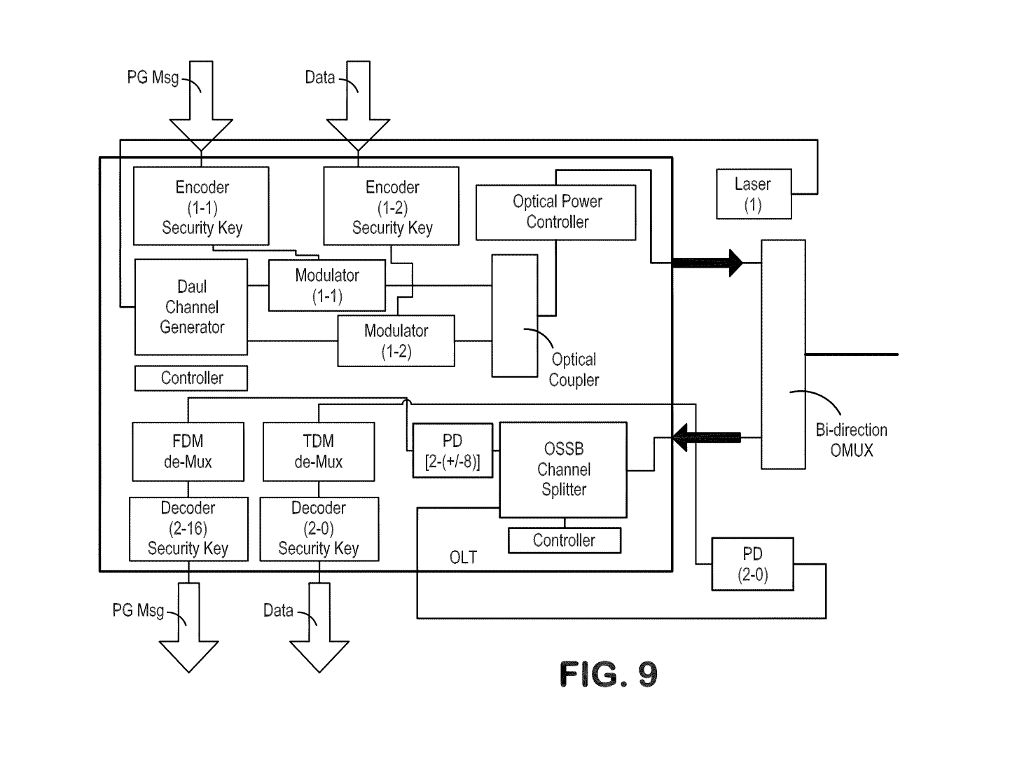

FIG. 9 illustrates a block diagram of an example OLT in accordance with embodiments. Details of the optical and electronic components that constitute an optical line terminal indicating separately downstream and upstream. From source provider to customer is downstream and implemented by the dual channel generator, controller, modulator (1-1), modulator (1-2), optical coupler, optical power controller, and laser (1), which are operatively connected together as shown. Upstream is customer to source provider and implemented by the PD [2-(+/−8)], the OSSB splitter, controller, and the PD (2-0), which are operatively connected together as shown.

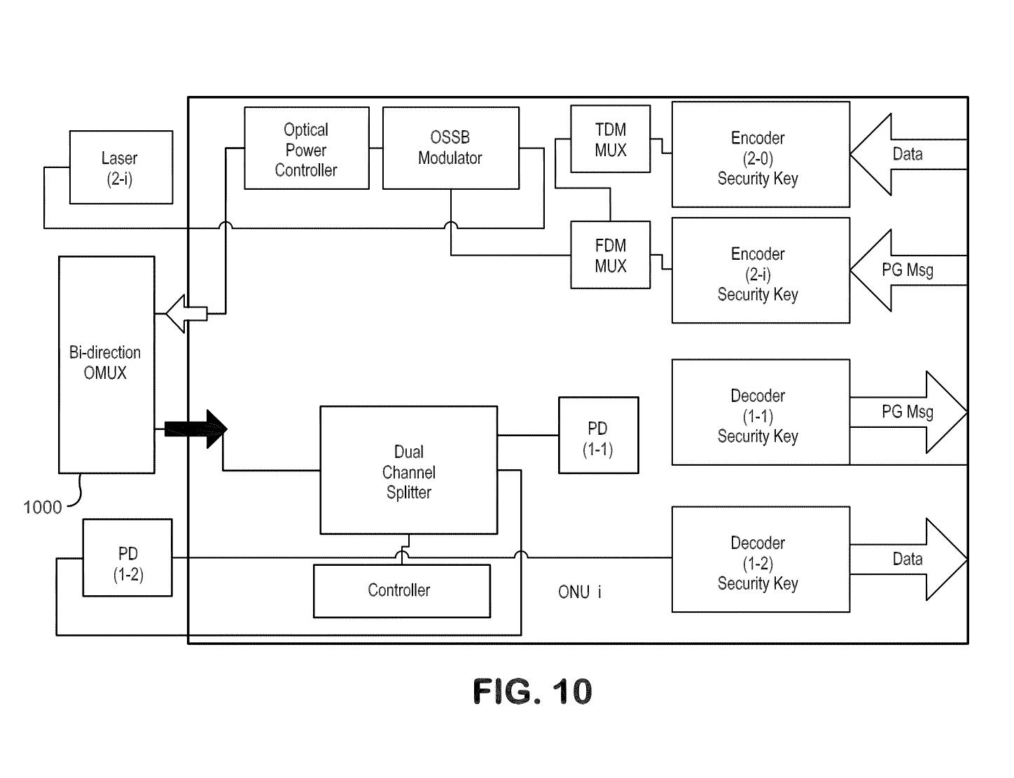

FIG. 10 illustrates a block diagram of an example ONU in accordance with embodiments. Details of optical and electronics components that encode, decode, receive and transmit the light for both downs and upstreams are provided. OMUX 1000 is a multiplexer configured for optical multiplexing of data. From source provide to customer is downstream and implemented by the dual channel splitter, controller, PD (1-1), PD (1-2), which are operatively connected together as shown. Upstream is customer to source provicer and implemented by the laser (2-i), optical power controller, and OSS modulator, which are operatively connected together as shown.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A network unit comprising:
a communications module configured to receive a single wavelength signal having first and second channels, the first channel carrying Internet data, and the second channel carrying power grid control and monitoring data; and
a multiplexer configured to multiplex the Internet data and the power grid control and monitoring data.

2. The network unit of claim 1, wherein the multiplexer is a wavelength-division multiplexer.

3. The network unit of claim 1, wherein the communications module is configured to receive signals via an optical fiber.

4. The network unit of claim 3, further comprising a light detector configured to detect light received from the optical fiber.

5. The network unit of claim 3, further comprising a laser configured to transmit light through the optical fiber.

6. The network unit of claim 1, further comprising at least one processor and memory configured to:
determine power requirements at a residence; and
control the communications module to communicate the power requirements to another network unit via the second channel.

7. The network unit of claim 1, wherein the power grid control and monitoring data is next generation electric power grid (NGEPG) data.

8. The network unit of claim 1, further comprising a plurality of inputs for receiving power requirement information from multiple electric devices.

9. The network unit of claim 8, further comprising at least one processor and memory configured to:
determine power requirements of the multiple electric devices; and
control the communications module to communicate the power requirements to another network unit via the second channel.

10. A method comprising:
at a network unit:
receiving a single wavelength signal having first and second channels, the first channel carrying Internet data, and the second channel carrying power grid control and monitoring data; and
multiplexing the Internet data and the power grid control and monitoring data.

11. The method of claim 10, wherein multiplexing comprises using a multiplexer to multiplex the Internet data and the power grid control and monitoring data.

12. The method of claim 11, wherein the multiplexer is a wavelength-division multiplexer.

13. The method of claim 10, wherein receiving comprises receiving the signal via an optical fiber.

14. The method of claim 13, wherein receiving the signal comprises using a light detector to detect light received from the optical fiber.

15. The method of claim 13, further comprising transmitting light through the optical fiber.

16. The method of claim 15, wherein transmitting light comprises using a laser to transmit light through the optical fiber.

17. The method of claim 10, further comprising:
determining power requirements at a residence; and
communicating the power requirements to another network unit via the second channel.

18. The method of claim 10, wherein the power grid control and monitoring data is next generation electric power grid (NGEPG) data.

19. The method of claim 10, further comprising receiving power requirement information from multiple electric devices.

20. The method of claim 19, further comprising:
determining power requirements of the multiple electric devices; and
communicating the power requirements to another network unit via the second channel.
